(19) United States
(12) Patent Application Publication
(10) Pub. No.: US 2026/0266533 A1
(43) Pub. Date: Sep. 10, 2026

(54) DOOR BODY ASSEMBLY OF EMBEDDED REFRIGERATION APPARATUS, AND EMBEDDED REFRIGERATION APPARATUS

(71) Applicants: HEFEI MIDEA REFRIGERATOR CO., LTD., Hefei (CN); HEFEI HUALING CO., LTD., Hefei (CN); MIDEA GROUP CO., LTD., Foshan (CN)

(72) Inventors: Xingxing Li, Hefei (CN); Zhanwei Liu, Hefei (CN); Bo Xie, Hefei (CN)

(21) Appl. No.: 19/161,236

(22) PCT Filed: Nov. 19, 2024
(86) PCT No.: PCT/CN2024/132869

§ 371 Date: Aug. 30, 2025

(30) Foreign Application Priority Data
Nov. 27, 2023 (CN) 202323218961.3
Jan. 22, 2024 (CN) 202410088590.1
Aug. 26, 2024 (CN) 202411187429.6

(51) Int. Cl. F25D 23/02

(52) U.S. Cl. CPC F25D 23/028; F25D 2500/02

(57) ABSTRACT

The present application relates to the technical field of refrigeration, and provides a door body assembly of an embedded refrigeration apparatus, and an embedded refrigeration apparatus. The door body assembly of the embedded refrigeration apparatus comprises: a door, rotatably connected to a refrigeration cabinet of the refrigeration apparatus, wherein the refrigeration cabinet is configured to be embedded into an accommodating space formed by a mount body; and a door plate, connected to the door by means of a sliding mechanism so as to move in the width direction of the door. The door has a critical door opening angle, and the critical door opening angle is smaller than the maximum door opening angle of the door; when the door rotates from a closed position to the critical door opening angle, the sliding mechanism drives the door plate to move relative to the door, the moving distance is Δs, and corresponds to the critical door opening angle, and the moving distance Δs is not smaller than a critical safety distance; the critical safety distance is the minimum sliding distance for achieving non-interference between the door plate and the outside when the door rotates from the closed position to the maximum opening angle; the door plate is static relative to the door when the door rotates from the critical door opening angle to the maximum door opening angle.

### CROSS-REFERENCES TO RELATED APPLICATIONS

The present application claims priority to Chinese patent application No. 202323218961.3 filed on Nov. 27, 2023, entitled “Refrigerator Hinge”, to Chinese patent application No. 202410088590.1 filed on Jan. 22, 2024, entitled “Door Body Assembly and Refrigeration Apparatus”, and to Chinese patent application No. 202411187429.6 filed on Aug. 26, 2024, entitled “Door Body Assembly of Embedded Refrigeration Apparatus and Embedded Refrigeration Apparatus”, which are hereby incorporated by reference in their entireties.

### FIELD

The present application relates to the field of refrigeration, and in particular to a door body assembly for an embedded refrigeration apparatus and an embedded refrigeration apparatus.

### BACKGROUND

In modern society, rapid advancement of science and technology has greatly promoted changes in home lifestyles. Embedded furniture, as a design concept that combines beauty and practicality, has gained popularity among consumers. Embedded furniture cleverly integrates appliances or a storage space into the home, effectively saving space and significantly enhancing the overall harmony and aesthetics of the home. An embedded refrigerator, as an example, is allowed to be seamlessly embedded into the cupboard, blending perfectly with the kitchen's decoration style and creating a modern and harmonious living environment. However, despite the significant advantages of embedded refrigerators in enhancing home aesthetics and space utilization, they still present a significant practical issue: box doors may easily interfere with or collide with sidewalls of the cupboard during opening, resulting in poor user's experience.

### BRIEF SUMMARY

The present application provides a door body assembly for an embedded refrigeration apparatus that can solve a problem that the door body assembly interferes and collides and improve users' experience.

The present application further provides an embedded refrigeration apparatus.

According to an embodiment of the present application, there is provided a door body assembly for an embedded refrigeration apparatus, including:
a box door rotatably connected to a refrigeration box body of the embedded refrigeration apparatus, where the refrigeration box body is embedded into an accommodation space formed by a mount body;
a slide mechanism; and
a door panel connected to the box door through the slide mechanism and moving relative to a width direction of the box door;
wherein the box door has a critical door opening angle, and the critical door opening angle is less than a maximum door opening angle of the box door; and
during a rotating process of the box door from a closed position to the critical door opening angle, the slide mechanism drives the door panel to move relative to the box door by a movement distance Δs, and the movement distance Δs corresponds to the critical door opening angle and is not less than a critical safety distance; the critical safety distance is a minimum sliding distance required for the door panel to avoid interference with outside during a rotating process of the box door from a closed position to the maximum door opening angle and the door panel remains stationary relative to the box door during a rotating process of the box door from the critical door opening angle to the maximum door opening angle.

According to the door body assembly for the embedded refrigeration apparatus in the embodiment of the present application, during the door body assembly opening process, the door panel stops relative sliding before reaching the maximum door opening angle. Specifically, during a latter portion of the door opening, the door panel remains stationary relative to the box door and the structural stability of the door body assembly may be improved, making the movement of the door panel more discreet and reducing users' concerns about falling off of the door panel. Furthermore, since larger the opening angle of the door body assembly, the closer it is to the user, the door panel early stops sliding to reduce the impact of noise during the door opening process and improve the users' experience.

According to an embodiment of the present application, the critical safety distance is a difference between a length L2 of the door panel extending beyond the accommodation space and a length L1 of the box door extending beyond the accommodation space, where L2=y+c+d2, L1=y−{x−(a−b)+d3+h}, and L2−L1=c+d2+{x−(a−b)+d3+h};

where y is a width of the box door, c is a difference between a width of the door panel and the width of the box door, d2 is a fit-up gap reserved for a cupboard door and a panel of the mount body when the box door is opened to the maximum door opening angle, x is a thickness of the box door, a is a longitudinal shaft distance of the box door, i.e., a distance between an inner surface and a hinge shaft center of the box door in case that the box door is closed, b is a transverse shaft distance of the box door, i.e., a distance between an end surface on a hinge side and the hinge shaft center of the box door in case that the box door is closed, d3 is a fit-up gap between the box door and the cupboard door, and h is a thickness of the cupboard door.

According to an embodiment of the present application, the door panel has a first interference position and a second interference position, the first interference position is located at an inner corner of the door panel on a door-opening side, and the second interference position is located at an outer corner of the door panel on a hinge side; and

the critical safety distance satisfies the following conditions: before the first interference position moves away from the accommodation space, a gap exists between the first interference position and a side wall of the accommodation space corresponding to the first interference position; when the second interference position moves away from the accommodation space, a gap exists between the second interference position and a side wall of the accommodation space corresponding to the second interference position.

According to an embodiment of the present application, the critical safety distance further satisfies the following conditions: after the second interference position moves away from the accommodation space, a gap exists between the second interference position and a panel of the mount body.

According to an embodiment of the present application, the critical door opening angle is between 1° and 105°.

According to an embodiment of the present application, the maximum door opening angle is between 90° and 135°.

According to an embodiment of the present application, the slide mechanism includes:
a pedestal provided with a second rail and a third rail;
a second movement member slidably mounted at the second rail;
a third movement member slidably mounted at the third rail and connected to the door panel; and
a connector having a second end connected to the second movement member and a second end connected to the third movement member.

According to an embodiment of the present application, the connector includes:
a first flexible cable passing through a first end of the pedestal, where two ends of the first flexible cable are connected to a first end of the second movement member and the third movement member, respectively; and
a second flexible cable passing through a second end of the pedestal, where two ends of the second flexible cable are connected to a second end of the first movement member and the second movement member, respectively.

According to an embodiment of the present application, an embedded refrigeration apparatus includes:
a refrigeration box body embedded in an accommodation space; and
the door body assembly mentioned above.

According to an embodiment of the present application, there is provided a method for controlling a door body assembly for an embedded refrigeration apparatus, including:
determining a critical safety distance for the door body assembly when rotating relative to a refrigeration box body based on dimensional parameters of the door body assembly, where the refrigeration box body of the refrigeration apparatus is embedded in an accommodation space formed by a mount body, a box door of the door body assembly is rotatably connected to the refrigeration box body, and a door panel of the door body assembly is movably mounted at the box door and movable along a width direction of the box door, and the critical safety distance is a minimum sliding distance required for the door panel to avoid interference with outside during a rotating process of the box door from a closed position to a maximum door opening angle; and
during a box door opening process, determining that a movement distance Δs of the door panel toward a door opening side of the box door reaches the critical safety distance, and controlling the door body assembly to stop movement relative to the box door.

Additional aspects and advantages of the present application are set forth in part in the description which follows and, in part, are apparent from the description, or may be learned by practice of the present application.

### BRIEF DESCRIPTION OF THE DRAWINGS

To more clearly illustrate solutions in the embodiments of the present application or the related art, the drawings that need to be used in the descriptions of the embodiments or the related art will be briefly described below. The drawings in the following description are only certain embodiments of the present application, and for those skilled in the related art, other drawings may be obtained based on these drawings without any creative work.

FIG. 1 is a first mounting schematic diagram of a door body assembly for an embedded refrigeration apparatus according to the embodiment of the present application;

FIG. 2 is a second mounting schematic diagram of a door body assembly for an embedded refrigeration apparatus according to the embodiment of the present application;

FIG. 3 is a first partial enlarged schematic diagram of FIG. 2;

FIG. 4 is a simplified schematic diagram of boundary conditions required for the door panel to not interfere with cupboard panels on either side during opening and closing according to an embodiment of the present application;

FIG. 5 is a first partial enlarged schematic diagram of FIG. 4;

FIG. 6 is a second partial enlarged schematic diagram of FIG. 4;

FIG. 7 is a schematic structural diagram of a door body assembly for a refrigeration apparatus according to the embodiment of the present application;

FIG. 8 is a third mounting schematic diagram of a door body assembly for an embedded refrigeration apparatus according to the embodiment of the present application;

FIG. 9 is a partial schematic structural diagram of a slide mechanism according to an embodiment of the present application; and

FIG. 10 is a schematic diagram of an assembly relationship between a traction mechanism and a slide mechanism of a door body assembly for an embedded refrigeration apparatus according to an embodiment of the present application.

1: refrigeration box body; 2: box door; 3: driven assembly; 4: slide mechanism; 401: second rail; 402: third rail; 403: second movement member; 404: third movement member; 406: rack; 407: gear; 6: cupboard; 601: first cupboard panel; 602: second cupboard panel; 9: door panel; 10: hinge; 101: hinge shaft center.

### DETAILED DESCRIPTION

Embodiments of the present application are further described in detail below with reference to the drawings and embodiments. The following embodiments are intended to illustrate the application, but are not intended to limit the scope of the application.

In the description of the embodiments of the present application, it should be noted that the orientation or positional relationships indicated by the terms such as “center,” “longitudinal,” “lateral,” “upper,” “lower,” “front,” “back,” “left,” “right,” “vertical,” “horizontal,” “top,” “bottom,” “inside,” and “outside,” are based on the orientation or positional relationship shown in the drawings, and are merely for the convenience of describing the embodiments of the present application and simplifying the description, rather than indicating or implying that the device or component stated must have a particular orientation, or be constructed and operated in a particular orientation, and thus cannot be understood as limitation to the embodiments of the present application. Furthermore, the terms “first,” “second,” “third” and the like are only used for descriptive purposes and should not be construed as indicating or implying a relative importance.

In the description of embodiments of the present application, it should be noted that, unless otherwise explicitly specified and defined, the terms “connected to” and “connected” shall be understood broadly. For example, it may be either fixedly connected or detachably connected, or may be integrally connected; it may be either mechanically connected, or electrically connected; it may be either directly connected, or indirectly connected through an intermediate medium. The specific meanings of the terms above in embodiments of the present application may be understood by those skilled in the art in accordance with specific circumstances.

In the embodiments of the present application, unless otherwise clearly stated and defined, the first feature being located “on” or “under” the second feature may mean that the first feature is in direct contact with the second feature or the first feature is in indirect contact with the second feature by an intermediate medium. In addition, the first feature being located “on,” “above” and “over” the second feature may refer to that the first feature is directly above or obliquely above the second feature, or simply refer to that the level of the first feature is higher than that of the second feature. The first feature being located “under,” “below” and “on bottom of” the second feature may mean that the first feature is directly under or below the second feature, or simply means that the level of the first feature is lower than the second feature.

In the description of the present specification, description with reference to the terms “one embodiment,” “some embodiments,” “an example,” “specific example,” “some examples” and the like, refers to that specific features, structures, materials or characteristics described in combination with an embodiment or an example are included in at least one embodiment or example of the embodiments of the present application. In the present specification, the schematic expressions of the above terms are not necessarily directed to the same embodiment or example. Also, the described specific features, structures, materials or characteristics can be combined in any one or more embodiments or examples in a suitable manner. In addition, those skilled in the art may combine the different embodiments or examples described in this specification, as well as the features of the different embodiments or examples, without conflicting each other.

In today's society, rapid advancement of science and technology has greatly promoted changes in home lifestyles. Embedded furniture, as a design concept that combines beauty and practicality, has gained popularity among consumers. Embedded furniture cleverly integrates appliances or a storage space into the home, effectively saving space and significantly enhancing the overall harmony and aesthetics of the home. An embedded refrigerator, as an example, is allowed to be seamlessly embedded into the cupboard, blending perfectly with the kitchen's decoration style and creating a modern and harmonious living environment. However, despite the significant advantages of embedded refrigerators in enhancing home aesthetics and space utilization, they still present a significant practical issue: box doors can easily interfere with or collide with sidewalls of the cupboard during opening, resulting in poor user's experience.

Specifically, in case that embedded refrigerators (referred simply to as refrigerators) meet different usage requirements of a user for both fully embedded flush and fully embedded refrigerators at the same time, the connection between the box door body (referred to as the box door) and the cupboard door panel (referred to as the door panel) can cause the entire door assembly to become thicker, resulting in that after the refrigerator is pushed inside an accommodation space of a cupboard, a door body assembly interfere with the door during opening and closing, relying solely on the refrigerator's hinges with a single shaft or dual shafts, making it impossible to open and use the refrigerator properly.

Therefore, the present application provides a door body assembly that allows relative sliding between the box door and the door panel (hereinafter referred to as a door body assembly). When the door body assembly is opened, the door panel slides toward the side where the door is opened (i.e., a door-opening side). During the box door opening process, a hinge side maintains the thickness of the box door itself, which is consistent with a door opening scenario without a door panel. During the box door closing process, the door panel moves toward the hinge side to return to its pre-opening state, which can satisfy requirements that the refrigerator is mounted in an embedded manner in the case with or without a door panel.

If the door panel and the box door continue to slide relative to each other, a sliding distance of the door panel of the box door is greater when the door opening angle is large, causing users to panic and concern that the door panel will fall off, affecting the users' experience. This concern is particularly obvious when the refrigerator is fully loaded or the refrigerator is tall. The present application further provides a door body assembly for an embedded refrigeration apparatus that can solve a problem that a door panel interferes and allow the door panel to stop moving relative to a box door as the box door is opened to a certain angle to improve users' experience.

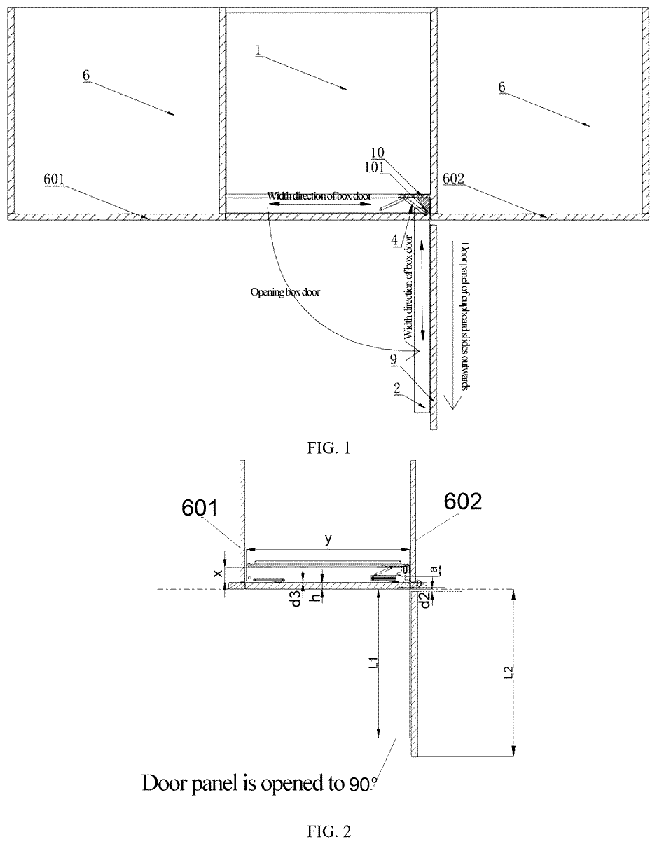

Referring to FIG. 1 and FIG. 2, the door body assembly includes a box door 2, a slide mechanism 4, and a door panel 9. The box door 2 is rotatably connected to a refrigeration box body 1 of the refrigeration apparatus, and the refrigeration box body 1 is embedded into an accommodation space formed by a mount body. The mount body here generally refers to a cupboard 6. In an embodiment, the mount body can also be a corner of a wall, or the mount body can also refer to other components, as long as it can form an accommodating space. Description is made below by taking the mount body as the cupboard 6 as an example. The door panel 9 is connected to the box door 2 through the slide mechanism 4 to move relative to a width direction of the box door 2. The box door 2 has a critical door opening angle, and the critical door opening angle is less than a maximum door opening angle of the box door 2. During a rotating process of the box door 2 from a closed position to the critical door opening angle, the slide mechanism drives the door panel 9 to move relative to the box door 2. During a rotating process of the box door 2 from the critical door opening angle to the maximum door opening angle, the door panel 9 remains stationary relative to the box door 2. During the rotating process of the box door 2 from the closed position to the critical door opening angle, a movement distance Δs of the door panel 9 needs to ensure that the door panel 9 does not interfere during an entire door opening process. Therefore, the movement distance Δs is not less than the critical safety distance and the critical safety distance is a minimum sliding distance required for the door panel to avoid interference with outside during the rotating process of the box door from the closed position to the maximum door opening angle.

According to an embodiment of the present application, during the door body assembly opening process, the door panel 9 stops relative sliding before reaching the maximum door opening angle. Specifically, during a latter portion of the door opening, the door panel 9 remains stationary relative to the box door 2 and the structural stability of the door body assembly may be improved, making the movement of the door panel 9 more discreet and reducing users' concerns about falling off of the door panel 9. Furthermore, since larger the opening angle of the door body assembly, the closer it is to the user, the door panel 9 early stops sliding to reduce the impact of noise during the door opening process and improve the users' experience.

According to an embodiment of the present application, the range of the critical safety distance may be determined in a variety of different ways.

In an embodiment, if the maximum door opening angle of the door body assembly is 90°, then, to ensure that the door body assembly does not interfere, a necessary condition is that, when the box door 2 is opened to 90°, a fit-up gap d2 exists between the door panel 9 and a panel of a cupboard 6. Here, the panel of the cupboard 6 is a second cupboard panel 602 in the drawing, and a first cupboard panel 601 also belongs to the panel of the cupboard 6. To ensure that the fit-up gap d2 exists between the door panel 9 and the panel of the cupboard 6 when the box door 2 is opened to 90°, the movement distance of the door panel 9 relative to the box door 2 is L2−L1=c+d2+{x−(a−b)+d3+h}. Furthermore, as long as the movement distance Δs is no less than L2−L1, the door panel 9 is ensured to not interfere with the outer surface of the second cupboard panel 602 when the box door 2 is opened to 90°. The fit-up gap d2 is generally greater than zero. However, in extreme cases, the fit-up gap d2 may also be zero, and the door panel 9 does not contact with the second cupboard panel 602 when the box door 2 is opened to 90°;

$$L 2 = y + c + d 2 , L 1 = y - \{ x - ( a - b ) + d 3 + h \} , and$$

$$L 2 - L 1 = c + d 2 + \{ x - ( a - b ) + d 3 + h \} ;$$

y is a width of the box door 2, c (not labeled in the drawing, as are some other parameters not labeled in the drawing below)) is a difference between a width of the door panel 9 and the width of the box door 2, d2 is a fit-up gap reserved for a cupboard door and a panel of the mount body when the box door 2 is opened to the maximum door opening angle, x is a thickness of the box door 2, a is a longitudinal shaft distance of the box door 2, i.e., a distance between an inner surface and a hinge shaft center of the box door 2 in case that the box door 2 is closed, b is a transverse shaft distance of the box door 2, i.e., a distance between an end surface on a hinge side and the hinge shaft center of the box door 2 in case that the box door 2 is closed, d3 is a fit-up gap between the box door 2 and the cupboard door, and h is a thickness of the cupboard door.

According to an embodiment of the present application, when the fit-up gap d3 between the box door 2 and the cupboard door is 6 mm and the thickness h of the door panel 9 is 23 mm, the total thickness of the door body assembly is x+d3+h=x+29.

When the door panel 9 is opened to 90°, a distance L1 of the box door 2 extending beyond the edge of the cupboard 6 is y−{x−(a−b)+d3+h}. When the transverse shaft distance b of the box door 2 is 12.5 mm, L1=y−{x−(a−12.5)+6+23}=y−x+a+41.5.

When the door panel 9 is opened to 90°, a distance L2 of the box door 2 extending beyond the edge of the cupboard 6 is y+c+d2. When the difference c between the width of the door panel 9 and the width of the box door 2 is 8 mm, and the fit-up gap d2 reserved for the cupboard door and the mounting panel when the box door 2 is opened to its maximum door opening angle is 5 mm, y+c+d2=y+13.

When the door panel 9 is opened to 90°, the distance that the door panel 9 extends beyond the box door 2 is L2−L1=y+l3−(y−x+a+41.5)=x+a+54.5. All units in the above formula are in millimeters.

That is, when the movement distance Δs that the box door moves relative to the box door 2 reaches x+a+54.5, the box door 2 cannot interfere with the second cupboard panel 602 throughout the entire 90° door opening process. During the door opening process, the earlier this distance is achieved, the better the users' experience. Specifically, sliding between the box door 2 and the door panel 9 occurs only at the beginning of the door opening. Subsequently, as the door opening angle increases, the load and weight-bearing sensation of the box door 2 gradually increase. At this point, the box door 2 and the door panel 9 no longer slide relative to each other to enhance the stability of the refrigerator.

Based on the above requirements, in the present embodiment, the parameters of the slide mechanism are determined using motion simulation or formula calculations. In case that the slide mechanism is implemented using a link, a length and an initial angle of the link may be calculated. In case that the slide mechanism is implemented using a gear transmission, the number of teeth in a gear and pressure angle may be calculated. This allows the box door 2 and door panel 9 to slide relative to each other when the door is initially opened, but stops when the box door 2 is opened to a certain angle. That is, when the box door 2 is fully opened, the box door 2 and door panel 9 are relatively stationary to improve the users' experience.

Taking the slide mechanism being a link mechanism as an example, the length of the link is set to m and the initial angle is set to be a. Displacement values corresponding to different door opening angles when the link length and initial angle are set to a certain value may be determined using Adams motion simulation or theoretical calculations. A door opening angle corresponding to the aforementioned relative sliding distance is simply found and the corresponding length of link and the initial angle may then be determined. The door panel 9 and box door 2 no longer slide relative to each other if the box door is opened beyond the initial angle. Similarly, the opposite occurs when the box door is closed. The box door 2 and door panel 9 do not slide relative to each other at the beginning of closing and the box door 2 and door panel 9 begin to slide when a certain angle is reached until the box door 2 is fully closed. A box door 2 with a width of 595 mm, a longitudinal shaft distance of 47 mm, and a transverse shaft distance of 14 mm is taken as an example. When the length of the link is 77 mm and the initial angle is 14.5°, the displacement relationship is shown in Table 1. The corresponding parameters are queried in the table based on the final required distance of the door panel 2 extending beyond the box door 2. Specifically, when the critical safety distance of 61 mm is required for the door panel 9 to extend beyond the box door 2, the door opening angle of 50° is enough and no relative sliding is required at subsequent 40° opening process. Based on parameters such as the actual door thickness, the link parameters can be adjusted to reduce the opening angle at which sliding stops.

| Critical Door Opening Angle | Critical Safety Distance | |
|---|---|---|
| 1° | 0.88 | mm |
| 2° | 1.78 | mm |
| 3° | 2.71 | mm |
| 4° | 3.67 | mm |
| 5° | 4.65 | mm |
| 10° | 9.91 | mm |
| 30° | 35 | mm |
| 50° | 61.47 | mm |
| 105° | 105.76 | mm |

In another embodiment, to determine the critical safety distance, a first interference position and a second interference position on the door panel 9, which are most likely to interfere, can be determined and the range of values for the critical safety distance can be determined based on the assumption that the first interference position and the second interference position always do not interfere with the accommodation space.

Referring to FIG. 4 to FIG. 6, according to an embodiment of the present application, the door panel 9 has a first interference position (point c) and a second interference position (point d), the first interference position is located at an inner corner of the door panel 9 on a door opening side, and the second interference position is located at an outer corner of the door panel 9 on a hinge side. The “inner” and “outer” are relative to the refrigeration box body 1. The side facing the refrigeration box body 1 is the “inner” side, and the side facing away from the refrigeration box body 1 is the “outer” side. Since FIG. 4 is a top view, the first interference position and the second interference position are a point in FIG. 4. It can be understood that for the door body assembly, the first interference position and the second interference position are a vertical line, respectively. If the inner corner of the door-opening side is arc-shaped, the first interference position is a point on the arc-shaped segment farthest from a hinge shaft center 101 of the box door 2. Similarly, if the outer corner of the door panel 9 on the hinge side is arc-shaped, the second interference position is the point on the arc-shaped segment farthest from the hinge shaft center 101 of the box door 2. The critical safety distance satisfies the following conditions: before the first interference position moves away from the accommodation space, a gap exists between the first interference position and a side wall of the accommodation space corresponding to the first interference position; when the second interference position moves away from the accommodation space, a gap exists between the second interference position and a side wall of the accommodation space corresponding to the second interference position.

In conjunction with FIG. 4 to FIG. 6, in the case that the box door 2 is closed, a gap between an end surface of the door panel 9 on the door-opening side and a sidewall of the corresponding accommodation space is δ1 and a gap between an end surface of the door panel 9 on the hinge side and a sidewall of the corresponding accommodation space is δ2.

δ1 is not less than a movement distance 7 along the width direction of the accommodation space before the first interference position moves away from the accommodation space and γ is a vertical distance that the first interference position moves toward a sidewall of the corresponding accommodation space. δ2 is not less than a movement distance λ along the width direction of the accommodation space before the second interference position moves away from the accommodation space and λ is a vertical distance that the second interference position moves toward a sidewall of the corresponding accommodation space. That is, δ1≥γ, δ2≥λ “Before the first interference point moves away from the accommodation space” corresponds to a situation before the first interference position, point c is aligned with point e of cupboard 6, that is, the interference point c is located ahead of the horizontal line containing point e. “Before the second interference point moves away from the accommodation space” corresponds to a situation before the second interference position, point d is aligned with point e of cupboard 6, that is, the interference point d is located ahead of the horizontal line containing point f.

Generally, δ1>γ and δ2>λ are required, and extreme cases where δ1=γ and δ2=λ are not excluded. When the box door 2 is in the closed position, a width direction of the box door 2 aligns with a width direction of the accommodation space. As the box door 2 is opened, the width direction of the box door 2 forms an angle with the width direction of the accommodation space.

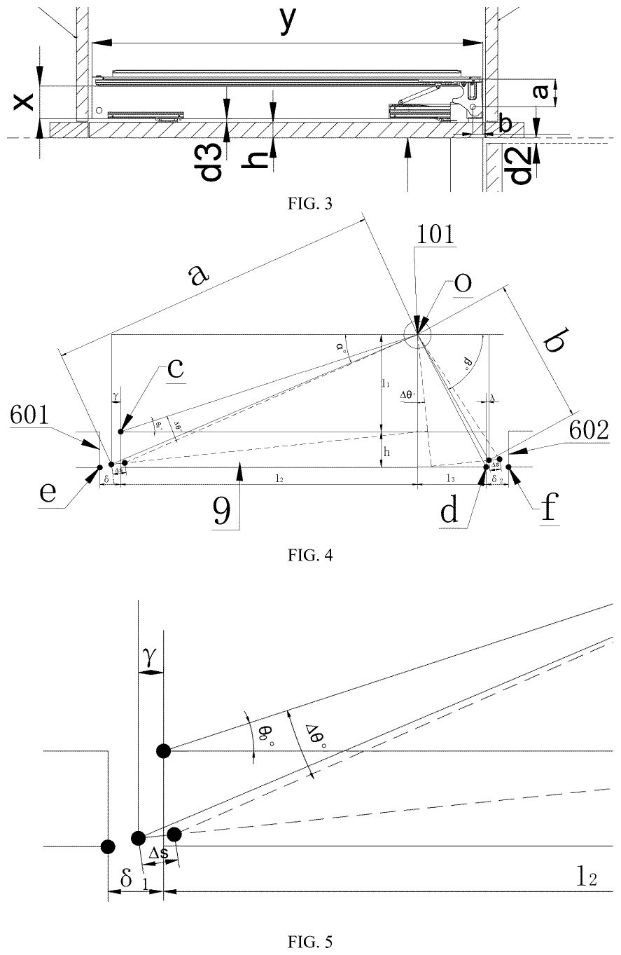

According to an embodiment of the present application, it is assumed that after the door panel 9 has moved a distance Δs, a length of an oblique line segment where the point c and the hinge shaft center 101 (i.e., o) are located is set to a, and an angle between the oblique line segment and the horizontal line in FIG. 3 is set to α. A length of an oblique line segment where point d and the hinge shaft center 101 (i.e., o) are located is set to b, and the angle between the oblique line segment and the horizontal line in FIG. 3 is set to β.

In FIG. 2 to FIG. 4, an initial position relationship (indicated by the dotted lines) and an angle relationship of the refrigeration apparatus (refrigerator) when the door is initially closed and when the box door 2 is opened to any angle are simplified and illustrated. In FIG. 2 to FIG. 4, corners where interference may occur during the box door opening process are labeled with black dots. The first interference position, point c, is likely to interfere with a point e on the right side of the first cupboard panel 601 close to an outward side, that is, point e is a critical point at which point c escapes interference (moves away from the accommodation space) during the door opening and closing process. The second interference position, point d, is a corner point on the right end of the door panel 9 close to an outward side and is the corner point where the right end surface of the door panel 9 first interferes with a left end surface of the second cupboard panel 602 adjacent to the right side during the door opening and closing process. As can be seen from FIG. 2 and FIG. 3, in the initial position, on the left side of the hinge shaft center 101, an angle between the oblique line segment oc where the point c and the hinge shaft center 101 are located and an inner side of the door panel is θ0, and the angle when the box door 2 is opened to any position is Δθ. At this position, the oblique line segment oc, the distance l2 and the distance l1 are represented by dotted lines. In the initial position, on the right side of the hinge shaft center 101, an oblique line segment where the point d and the hinge shaft center 101 are located is od, and the angle when the box door 2 is opened to any position is Δθ. At this position, the oblique line segment od, the distance l1+h and the distance l3 are represented by dotted lines. As can be seen from FIG. 2 and FIG. 3, if the door panel does not move toward the door-opening side along the box door 2 during the opening process of the box door 2, as the opening angle increases, point d will quickly interfere with the left end surface of the second cupboard panel 602, resulting in that the box door 2 fails to be opened. Therefore, to prevent this interference from affecting the door opening, the door panel 9 must be moved toward the door opening by a distance Δs when the door opening angle of the door body is Δθ during the door opening.

In an embodiment, δ1≥γ=a×cos α−l2;

where

$$a = \sqrt{{( l 1 )}^{2} + {( l 2 + Δ s )}^{2}} , α = 90 ° - [ arc tan ( \frac{l 2 + Δ s}{l 1} ) - Δθ ] .$$

As previously mentioned, Δθ is the angle of rotation during opening of the box door 2, and Δs is the distance that the door panel 9 moves relative to the door-opening side of the box door 2 during opening of the box door 2.

In an embodiment, δ2≥λ=b*cos β−l3;

where

$$b = \sqrt{{( l 1 + h )}^{2} + {( l 3 - Δ s )}^{2}} , β = 90 ° - [ arc tan ( \frac{l 3 - Δ s}{l 1 + h} ) + Δθ ] .$$

Therefore, in the case that l1, l2, l3, h, δ1 and δ2 are determined, the value range of Δs may be obtained.

The above formulas for calculating Δs do not limit Δs. For example, the above formulas may also include correction coefficients or parameters. Furthermore, the above formulas are based on a fixed hinge shaft center 101. If the box door 2 is mounted using biaxial hinges or movable hinges, the hinge shaft center 101 will change as the box door 2 is opened. Consequently, the formulas for calculating Δs will also change accordingly, and a movement distance of the hinge shaft center 101 needs to be calculated. Additionally, if there is a mounting gap between the door panel 9 and the box door 2, h in the above calculation formula is a distance between a slide surface of the door panel 9 and an outer surface of the door panel 9 and 11 is a distance from a hinge point of the box door 2 to the slide surface of the door panel 9.

In this case, δ1 and δ2 generally do not exceed 5 mm. For example, when δ1=δ2=4 mm, the range of Δs can be determined.

According to an embodiment of the present application, the critical door opening angle is between 1° and 105°. That is, after the box door 2 is opened to the critical door opening angle, the door panel 9 no longer slides relative to the box door 2 to ensure the stability of the door body assembly structure and improve the users' experience.

According to an embodiment of the present application, the maximum door opening angle is between 90° and 135°.

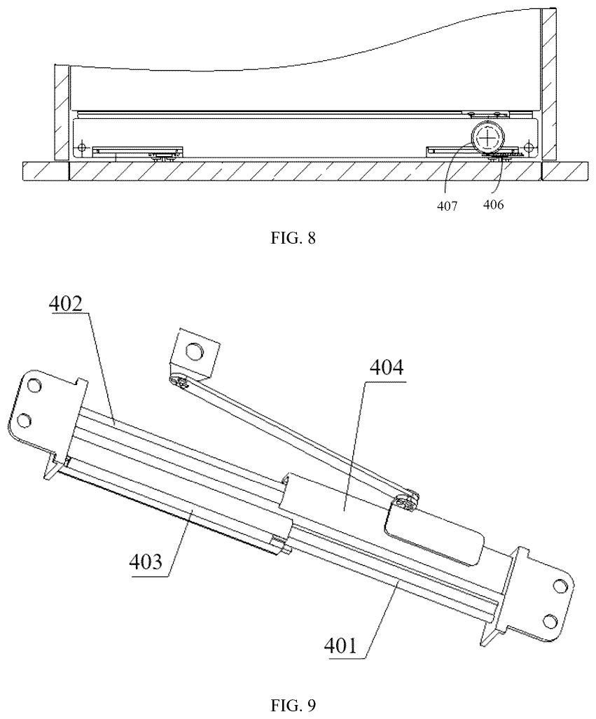

According to an embodiment of the present application, referring to FIG. 7, in addition to the slide mechanism 4 provided between the door panel 9 and the box door 2, a driven assembly 3 may further be provided to ensure smooth movement of the door panel 9. In conjunction with FIG. 7 to FIG. 9, the driven assembly 3 includes a first rail and a first movement member that slides relative to the first rail. In FIG. 7, the first rail and the first movement member may take the form of a slide rail and a slider. Alternatively, as shown in FIG. 8, the first rail may be the rack 406 of the slide mechanism 4, in which case the first movement member may be a gear 407 meshed with the rack 406. The specific structure of the first rail and the first movement member is not limited, as long as the first movement member can move along the first rail.

According to an embodiment of the present application, as shown in FIG. 9, the slide mechanism 4 includes a pedestal (not labeled) provided with a second rail 401 and a third rail 402; a second movement member 403 and a third movement member 404. The second movement member 403 is slidably mounted at the second rail 401, and the third movement member 404 is slidably mounted at the third rail 402 and is connected to the door panel 9. Two ends of a connector are connected to the second movement member 403 and the third movement member 404. A traction mechanism drives the second movement member 403 along the second rail 401, and the second movement member 403 in turn drives the third movement member 404 along the third rail 402 through the connector. The second movement member 403 and third movement member 404 move in opposite directions.

According to an embodiment of the present application, the connector may be a flexible cable, such as a steel wire rope, or other component capable of transmitting power between the second movement member 403 and third movement member 404. Furthermore, both the second rail 401 and the third rail 402 may be constructed as slide rails, in which case both the second movement member 403 and the third movement member 404 may be constructed as sliders. The specific structures of the second rail 401, the third rail 402, the second movement member 403, and the third movement member 404 are not limited to the examples given here, as long as the second movement member 403 slides along the second rail 401 and the third movement member 404 moves along the third rail 402.

According to an embodiment of the present application, the connector includes a first flexible cable and a second flexible cable. The first flexible cable bypasses a first end of the pedestal and two ends of the first flexible cable are connected to a first end of the second movement member 403 and the third movement member 404, respectively. The second flexible cable bypasses a second end of the pedestal and two ends of the second flexible cable are connected to a second end of the second movement member 403 and the third movement member 404, respectively.

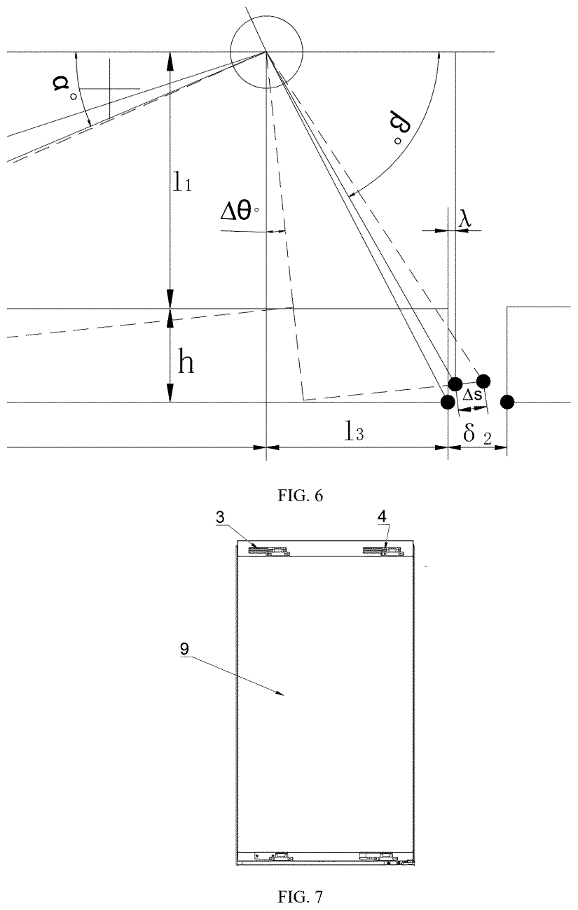

The specific structure of the slide mechanism 4 is not limited to the examples given here, as long as the traction mechanism drives the slide mechanism 4 to move to cause the door panel 9 to move relative to the box door 2. For example, the slide mechanism 4 may be the dual-rail and slider structure mentioned above, or may adopt a structure matching a gear 407 and a rack 406. Referring to FIG. 6, the slide mechanism 4 includes a gear 407 and a rack 406. The gear 407 is driven to rotate to drive the rack 406 to move. The gear 407 is connected to an output shaft of the traction mechanism, and the rack 406 is fixedly connected to the door panel 9.

According to an embodiment of the present application, during the opening process of the door body assembly, the door panel early remains stationary relative to the door before rotating to the maximum door opening angle.

In an embodiment, the movement of the door panel is controlled by a motor. For example, the motor drives the slide mechanism to move the door body relative to the box door. In this case, the start and stop of the motor is controlled through a controller to implement this goal.

In another embodiment, the movement of the door panel relative to the box door is driven through a mechanical structure. Specifically, by selecting a suitable slide mechanism, the slide mechanism can be ensured to have both an engaged state and a disengaged state. In the engaged state, the door panel may move relative to the box door under the drive of the slide mechanism; while in the disengaged state, the door panel remains stationary relative to the door. Specifically, the slide mechanism is in an engaged state before the movement distance Δs of the door panel reaches the critical safety distance while the slide mechanism is in a disengaged state after the movement distance Δs of the door panel reaches the critical safety distance.

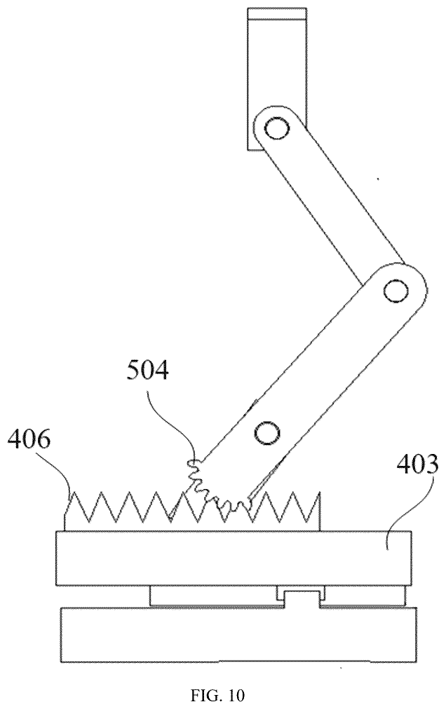

For example, referring to FIG. 10, the traction mechanism includes a curved gear 504 and a motor. The curved gear 504 has a teeth portion; the second movement member 403 is provided with a rack 406. In the engaged state, the rack 406 is meshed with the teeth; in the disengaged state, the rack 406 is separated from the curved gear 504. The motor is coupled to the curved gear 504 to drive the curved gear 504 to rotate. To switch between the engaged and disengaged states, the specific type of slide mechanism 4 is not limited to the above example.

According to an embodiment of the present application, an embedded refrigeration apparatus is provided, including a refrigeration box body 1 and a door body assembly. The refrigeration box body 1 is embedded in an accommodation space, and the door body assembly is mounted at the refrigeration box body 1.

According to an embodiment of the present application, there is provided a method for controlling a door body assembly of an embedded refrigeration apparatus, including:
step 10, determining a critical safety distance for the door body assembly when rotating relative to a refrigeration box body based on dimensional parameters of the door body assembly, where the refrigeration box body of the refrigeration apparatus is embedded in an accommodation space formed by a mount body, a box door of the door body assembly is rotatably connected to the refrigeration box body, and a door panel of the door body assembly is movably mounted at the box door and movable along a width direction of the box door, and the critical safety distance is a minimum sliding distance required for the door panel to avoid interference with outside during a rotating process of the box door from a closed position to a maximum door opening angle; and
step 20, during a box door opening process, determining that a movement distance Δs of the door panel toward a door opening side of the box door reaches the critical safety distance, and controlling the door body assembly to stop movement relative to the box door.

It should be noted that steps 10 and 20 above are merely for convenience of description and do not constitute a limitation on the chronological order.

In the step 20, the door opening angle of the door body assembly may be determined, and the current movement distance Δs may be indirectly determined based on the correspondence between the door opening angle and the movement distance Δs. For example, when the door body assembly is opened, the motor controls the movement of the door panel at a constant speed based on the door opening angle and a mapping relationship between the door opening angle and the movement distance Δs of the door panel may be obtained. The relationship between the door opening angle and the movement distance Δs of the door panel may be a simple linear relationship or a nonlinear relationship, as long as the door panels do not interfere with each other during the door opening process, which is not specifically limited here. A sensor may also be provided to directly detect the movement distance Δs of the current door panel.

In addition, it should be noted that all of the above descriptions of the door body assembly of an embedded refrigeration device may be used to explain the control method for the door body assembly of an embedded refrigeration device, and therefore any repetitive content is not repeated.

Finally, it should be noted that the above embodiments are only used to illustrate the present application, but not to limit the present application. Although the application has been described in detail with reference to the embodiments, those skilled in the art should understand that various combinations, modifications, or equivalent replacements of the solutions of the application do not depart from the scope of the solutions of the application, and should all cover the scope of the claims of the present application.

1. A door body assembly for an embedded refrigeration apparatus, comprising:
a box door rotatably connected to a refrigeration box body of the embedded refrigeration apparatus, wherein the refrigeration box body is embedded into an accommodation space formed by a mount body;
a slide mechanism; and
a door panel connected to the box door through the slide mechanism and moving relative to a width direction of the box door;
wherein the box door has a critical door opening angle, and the critical door opening angle is less than a maximum door opening angle of the box door; and
during a rotating process of the box door from a closed position to the critical door opening angle, the slide mechanism drives the door panel to move relative to the box door by a movement distance Δs, and the movement distance Δs corresponds to the critical door opening angle and is not less than a critical safety distance; the critical safety distance is a minimum sliding distance required for the door panel to avoid interference with outside during a rotating process of the box door from a closed position to the maximum door opening angle, and the door panel remains stationary relative to the box door during a rotating process of the box door from the critical door opening angle to the maximum door opening angle.

2. The door body assembly of claim 1, wherein the critical safety distance is a difference between a length L2 of the door panel extending beyond the accommodation space and a length L1 of the box door extending beyond the accommodation space, wherein L2=y+c+d2, L1=y−{x−(a−b)+d3+h}, and L2−L1=c+d2+{x−(a−b)+d3+h};
wherein y is a width of the box door, c is a difference between a width of the door panel and the width of the box door, d2 is a fit-up gap reserved for a cupboard door and a panel of the mount body when the box door is opened to the maximum door opening angle, x is a thickness of the box door, a is a longitudinal shaft distance of the box door, i.e., a distance between an inner surface and a hinge shaft center of the box door in case that the box door is closed, b is a transverse shaft distance of the box door, i.e., a distance between an end surface on a hinge side and the hinge shaft center of the box door in case that the box door is closed, d3 is a fit-up gap between the box door and the cupboard door, and h is a thickness of the cupboard door.

3. The door body assembly of claim 1, wherein the door panel has a first interference position and a second interference position, the first interference position is located at an inner corner of the door panel on a door-opening side, and the second interference position is located at an outer corner of the door panel on a hinge side; and
the critical safety distance satisfies the following conditions: before the first interference position moves away from the accommodation space, a gap exists between the first interference position and a side wall of the accommodation space corresponding to the first interference position; when the second interference position moves away from the accommodation space, a gap exists between the second interference position and a side wall of the accommodation space corresponding to the second interference position.

4. The door body assembly of claim 3, wherein the critical safety distance further satisfies: after the second interference position moves away from the accommodation space, a gap exists between the second interference position and a panel of the mount body.

5. The door body assembly of claim 1, wherein the critical door opening angle is between 1° and 105°.

6. The door body assembly of claim 1, wherein the maximum door opening angle is between 90° and 135°.

7. The door body assembly of claim 1, wherein the slide mechanism comprises:
a pedestal provided with a second rail and a third rail;
a second movement member slidably mounted at the second rail;
a third movement member slidably mounted at the third rail and connected to the door panel; and
a connector having a first end connected to the second movement member and a second end connected to the third movement member.

8. The door body assembly of claim 7, wherein the connector comprises:
a first flexible cable passing through a first end of the pedestal, wherein two ends of the first flexible cable are connected to a first end of the second movement member and the third movement member, respectively; and
a second flexible cable passing through a second end of the pedestal, wherein two ends of the second flexible cable are connected to a second end of the first movement member and the second movement member, respectively.

9. An embedded refrigeration apparatus, comprising:
a refrigeration box body embedded in an accommodation space; and
the door body assembly of claim 1.

10. A method for controlling a door body assembly for an embedded refrigeration apparatus, comprising:
determining a critical safety distance for the door body assembly when rotating relative to a refrigeration box body based on dimensional parameters of the door body assembly, wherein the refrigeration box body of the refrigeration apparatus is embedded in an accommodation space formed by a mount body, a box door of the door body assembly is rotatably connected to the refrigeration box body, a door panel of the door body assembly is movably mounted at the box door and movable along a width direction of the box door, and the critical safety distance is a minimum sliding distance required for the door panel to avoid interference with outside during a rotating process of the box door from a closed position to a maximum door opening angle; and
during a box door opening process, determining that a movement distance Δs of the door panel toward a door opening side of the box door reaches the critical safety distance, and controlling the door body assembly to stop movement relative to the box door.
